(19) United States
(12) Patent Application Publication
(10) Pub. No.: US 2013/0030147 A1
(43) Pub. Date: Jan. 31, 2013

(54) MANUFACTURING METHOD OF COLORED POLYLACTIC ACID RESIN

(71) Applicants: Chae Hwan Hong, Ansan (KR); Do Suck Han, Seongnam (KR)

(72) Inventors: Chae Hwan Hong, Ansan (KR); Do Suck Han, Seongnam (KR)

(73) Assignee: HYUNDAI MOTOR COMPANY, Seoul (KR)

(21) Appl. No.: 13/286,398

(22) Filed: Nov. 1, 2011

(30) Foreign Application Priority Data
Jul. 27, 2011 (KR) 10-2011-0074750

(51) Int. Cl. C08G 63/82

(52) U.S. Cl. 528/357

(57) ABSTRACT

Disclosed is a technique of providing color to a polylactic acid resin which is promising as a plant-derived material for automotive interior/exterior parts. When a polylactic acid material is used as a covering fiber material of an automotive interior part, coloring is necessary for harmonization with other parts in the car. According to the disclosed technique, color is provided to a polylactic acid resin using a combination of a catalyst and an initiator when it is polymerized from lactide. The disclosed method is time-saving and economical since a colored resin can be polymerized and thus the complicated process of dyeing a white resin using a disperse dye and washing and drying the same can be avoided.

### CROSS-REFERENCE TO RELATED APPLICATIONS

This application claims priority to Korean Patent Application No. 10-2011-0074750, filed on Jul 27, 2011, under 35 U.S.C. §119. The content of the aforementioned application is incorporated herein by reference in its entirety.

### BACKGROUND

(a) Technical Field

The present invention relates to a method for preparing colored polylactic acid by polymerization of lactide monomers using a combination of a catalyst and an initiator.

(b) Background Art

With rapid global population growth and industrial development, the use of fossil fuel resources is increasing rapidly and global warming caused by greenhouse gas emission and environmental pollution due to wastes have become a serious global issue. According to the United States Census Bureau, the world population increased from about 2 billion in 1800s to about 6.6 billion in 1999 and to about 6.7 billion in 2008. It is expected to reach 7 billion in 2012.

The development of the modern civilization might have been impossible without petroleum resources as an energy source. According to the recent data, the global crude oil reserve was about 1.2 trillion barrel as of 2004 and is expected to be depleted in about 40 years with the current production level. Over the past decades, the price of crude oil increased from about $17/barrel in 1995 to about $60/barrel in 2006 and over $100/barrel in 2008. It takes millions of years for the fossil fuel resources to be recycled. Petroleum and other fossil fuels are non-recyclable and will be depleted sometime in the future. Also, the fuels and materials derived the fossil fuels are causing serious problems worldwide by increasing carbon dioxide emissions.

Polymers derived from plants, i.e., biomass polymers, are prepared from renewable plant sources such as corn, bean, sugarcane, wood, etc. via chemical or biological processes. Their importance lies in reduced carbon dioxide emission rather than their biodegradability. Polylactic acid (or polylactide) is a linear aliphatic polyester among the biomass polymers, obtained from fermentation of corn starch or potato starch, or from polymerization of sugar monomers obtained by saccharification of cellulose followed by fermentation. It is a carbon neutral, environment-friendly, thermoplastic polymer material.

Although polylactic acid was first synthesized in the 1940s, its use has been limited in sutures or drug delivery systems because of high manufacturing costs and scarcity. In 1997, Cargill and Dow Chemical of the US formed a 50/50 joint venture called Cargill Dow Polymer (renamed as NatureWorks since December 2007). The company completed a polylactic acid production facility with an annual production capacity of 140,000 ton in 2002 and has been involved in the production of polylactic acid products for various applications, including films, cups, food containers and packaging with continued research thereon.

This material is industrially applicable in injection molding and fiber industries. In the field of injection molding, it is used in products requiring no heat resistance or, for use in automotive injection molding parts capable of enduring high temperature of 100° C. L-polylactic acid (PLLA) and D-polylactic acid (PDLA) are blended to form stereocomplexes.

In the fiber industry, fiber materials capable of replacing the existing petroleum-based polyester materials are actively developed. Fiber materials required a process of dyeing in order to provide color to resins. The dyeing is performed at high temperature of 130° C. or above by mixing the resin with a disperse dye. Since removal of unreacted disperse dyes is necessary following the dyeing process, a large volume of water is consumed. Further, the acidic condition of the dyeing process is detrimental to the environment.

At present, all polyester resins are dyed by the above-described process.

### SUMMARY

The current invention provides a technology capable of omitting the dyeing process when preparing industrially useful polylactic acid fiber materials. Specifically, the invention provides a method of preparing a polymerization catalyst having aluminum metal as major reaction site, and have developed a technology for providing color to a resin during the polymerization thereof using an initiator and a disperse dye.

Other features and aspects will be apparent from the following detailed description, the drawings, and the claims.

In one aspect, the present invention provides a method for preparing a colored poly lactic acid, comprising the steps of: (i) synthesizing an aluminum catalyst and one or more ligands in a solvent to form an aluminum catalyst complex; and (ii) polymerizing polylactic acid by adding lactide monomers and a color determining selective initiator to the solvent and catalyst complex of step (i).

### BRIEF DESCRIPTION OF THE DRAWINGS

The above and other objects, features and advantages of the present invention will now be described in detail with reference to certain exemplary embodiments thereof. The drawings are meant for illustration purposes only, and are not meant to limit the invention.

FIG. 1 schematically shows a process of preparing a colored poly lactic acid resin according to the present invention.

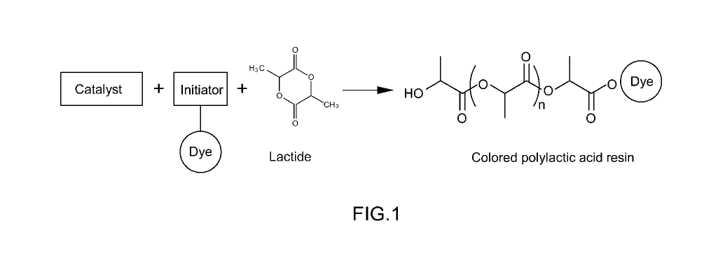

### DETAILED DESCRIPTION

Hereinafter, reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

In one aspect, the present invention provides a method for preparing a colored poly lactic acid, comprising the steps of: (i) synthesizing an aluminum catalyst and one or more ligands in a solvent to form an aluminum catalyst complex;

and (ii) polymerizing polylactic acid by adding lactide monomers and a color determining selective initiator to the solvent and catalyst complex of step (i).

In a specific embodiment of the present invention, the solvent is an organic solvent. More specifically, the organic solvent is toluene, benzene, pentane, cyclopentane, hexane, cyclohexane, chloroform, diethyl ether or 1,4-dioxane. More specifically, the organic solvent is toluene.

In a specific embodiment of the present invention, the aluminum catalyst complex is prepared by mixing 1 equivalent of trimethylaluminum with 2 equivalent of C₅H₄N(CO)NHC₆H₃(NO₂)₂.

In a specific embodiment of the present invention, the color determining selective initiator has an alcohol functional group. More specifically, the selective initiator having an alcohol functional group is HOCH₂(C₆H₄)N═N(C₆H₄)NH₂, 2-[N-ethyl-3-methyl-4-[(5-nitro-1,3-thiazol-2-yl)diazenyl]anilino]ethanol, 2-[4-(2-chloro-4-nitrophenyl)diazenyl-N-ethylanilino]ethanol, 1-pyrenebutanol or a mixture thereof. The diazo compound HOCH₂(C₆H₄)N═N(C₆H₄)NH₂ may have the substituents OH and NH₂ at any of ortho, meta and para positions of the benzene rings. Through diazo coupling, these compounds satisfy orbital conjugation and exhibit specific colors by absorbing light in the visible region.

In a specific embodiment of the present invention, the aluminum catalyst complex and the selective initiator are independently added in an amount of 0.1-5.0 part by weight based on 100 parts by weight of the lactide monomers. In a specific embodiment of the present invention, the aluminum catalyst complex and the selective initiator are independently added in an amount of 0.1-1.0 part by weight based on 100 parts by weight of the lactide monomers. In a specific embodiment of the present invention, the aluminum catalyst complex and the selective initiator are independently added in an amount of 0.3-0.8 part by weight based on 100 parts by weight of the lactide monomers. In a specific embodiment of the present invention, the aluminum catalyst complex and the selective initiator are independently added in an amount of 0.5-0.7 part by weight based on 100 parts by weight of the lactide monomers.

In a specific embodiment of the present invention, the polylactic acid polymerization is performed at 50-400° C. In a specific embodiment of the present invention, the polylactic acid polymerization is performed at 75-350° C. In a specific embodiment of the present invention, the polylactic acid polymerization is performed at 100-300° C. In a specific embodiment of the present invention, the polylactic acid polymerization is performed at 160-250° C.

In a specific embodiment of the present invention, the polylactic acid polymerization is performed for 0.1-10 hours. In a specific embodiment of the present invention, the polylactic acid polymerization is performed for 0.25-5 hours. In a specific embodiment of the present invention, the polylactic acid polymerization is performed for 0.5-3 hours.

In a specific embodiment of the present invention, the polylactic acid polymerization is performed at 160-250° C. for 0.5-3 hours. More specifically, the polymerization time is 0.5-1.5 hours.

In another aspect, the present invention provides a polylactic acid resin having a molecular weight of 10,000-500,000, which is prepared by the above-described method. In another aspect, the present invention provides a polylactic acid resin having a molecular weight of 25,000-300,000, which is prepared by the above-described method. In another aspect, the present invention provides a polylactic acid resin having a molecular weight of 50,000-200,000, which is prepared by the above-described method. More specifically, the polylactic acid has a molecular weight of 80,000-150,000.

In accordance with the present invention, a colored polylactic acid resin is prepared via lactide ring-opening polymerization using a combination of a catalyst used in lactide ring-opening polymerization and a disperse dye having a hydroxyl group.

In general, various metal catalysts and alcohols having hydroxyl groups are used as lactide polymerization catalyst. For instance, lactide is added to a reactor equipped with a stirrer and heated to 180° C. under nitrogen flow. Then, stannous octoate ([CH₃(CH₂)₃CH(C₂H₅)COO]₂Sn) is added. Subsequently, 1-hexanol is added as reaction initiator. The initiator serves to ionize stannous octoate.

In addition to stannous octoate, various other catalysts may be used. For example, aluminum isopropoxide ((Al(O-i-Pr)₃), yttrium isopropoxide ((C₉H₂₁O₃)Y), etc. may be used as catalyst.

In accordance with the present invention, the resin is prepared using a combination of an aluminum-based catalyst and the disperse dye as initiator.

Specifically, a catalyst consisting of aluminum metal and a coordinating ligand binds with the disperse dye initiator to make the aluminum in charged state. Then, lactide monomers are ring-opening polymerized to prepare the resin. The disperse dye initiator may be C.I. Disperse Blue 106, C.I. Disperse Red 13, or the like, but is not necessarily limited thereto.

### EXAMPLES

The examples and experiments will now be described. The following examples and experiments are for illustrative purposes only and not intended to limit the scope of this invention.

### Example 1

### Preparation of Yellow Polylactic Acid Resin

A yellow polylactic acid resin was prepared as follows. First, an aluminum catalyst was prepared as follows. 1 equivalent of trimethylaluminum was mixed with 2 equivalent of C₅H₄N(CO)NHC₆H₃(NO₂)₂ in toluene. An aluminum catalyst complex was formed from the reaction between the two reactants. The chemical structure of C₅H₄N(CO)NHC₆H₄(NO₂)₂ is shown in the formula 1:

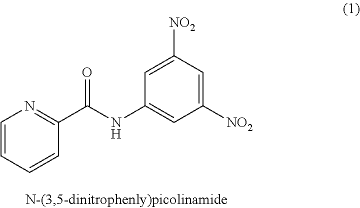 [SMILES: O=C(Nc1cc([N+](=O)[O-])cc([N+](=O)[O-])c1)c1ccccn1]

As an initiator for the preparation of the yellow resin, a benzyl alcohol compound having an azo functional group (HOCH₂(C₆H₄)N═N(C₆H₄)NH₂) was used.

Specifically, the aluminum catalyst complex and the compound having an azo functional group (HOCH₂(C₆H₄)N═N(C₆H₄)NH₂) were added to a reactor in an amount of 0.5-0.7 parts by weight, independently, based on 100 parts by weight of lactide. Then, the reaction temperature was maintained at 200° C. for 2 hours to obtain the desired resin.

### Example 2

### Preparation of Violet Polylactic Acid Resin

A violet polylactic acid resin was prepared as follows. An aluminum catalyst complex was prepared in the same manner as in Example 1.

As an initiator for the preparation of the violet resin, C.I. Disperse Blue 106 was used.

The chemical structure of C.I. Disperse Blue 106 is as follows:

2-[N-ethyl-3-methyl-4-[(5-nitro-1,3-thiazol-2-yl)diazenyl]anilino]ethanol (C₁₄H₁₇N₅O₃S)

The resin was polymerized in the same manner as in Example 1.

### Example 3

### Preparation of Red Polvlactic Acid Resin

A red polylactic acid resin was prepared as follows. An aluminum catalyst complex was prepared in the same manner as in Example 1.

As an initiator for the preparation of the violet resin, C.I. Disperse Red 13 was used.

The chemical structure of C.I. Disperse Red 13 is as follows:

2-[4-(2-chloro-4-nitrophenyl)diazenyl-N-ethylanilino]ethanol (C₁₆H₁₇ClN₄O₃)

The resin was polymerized in the same manner as in Example 1.

### Example 4

### Preparation of Fluorescent Polylactic Acid Resin

A fluorescent polylactic acid resin was prepared as follows. An aluminum catalyst complex was prepared in the same manner as in Example 1.

As an initiator for the preparation of the fluorescent resin, 1-pyrenebutanol was used.

The chemical structure of 1-pyrenebutanol is shown in the formula 2:

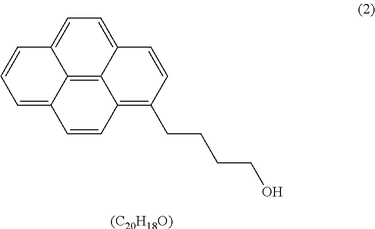 [SMILES: OCCCCc1ccc2ccc3cccc4ccc1c2c34 ; "(C20H18O)"]

The resin was polymerized in the same manner as in Example 1.

Molecular weight and color of the polymerized resins are summarized in Table

The features and advantages of the present invention can be summarized as follows.

(i) The present invention provides a method for preparing colored polylactic acid resins using a combination of an aluminum catalyst and an initiator.

(ii) The present invention allows for the preparation of colored polylactic acid resins with various colors using selective initiators which determine color.

(iii) The method according to the present invention is time-saving, economical and environment-friendly since a colored resin can be polymerized and thus the complicated process of dyeing a white resin using a disperse dye and washing and drying the same can be avoided.

The present invention has been described in detail with reference to specific embodiments thereof. However, it will be appreciated by those skilled in the art that various changes and modifications may be made in these embodiments without departing from the principles and spirit of the invention, the scope of which is defined in the appended claims and their equivalents.

### INCORPORATION BY REFERENCE

The contents of all references (including literature references, issued patents, published patent applications, and co-pending patent applications) cited throughout this application are hereby expressly incorporated herein in their entireties by reference.

### Equivalents

Those skilled in the art will recognize, or be able to ascertain using no more than routine experimentation, many equivalents of the specific embodiments of the invention described herein. Such equivalents are intended with be encompassed by the following claims.

What is claimed is:

1. A method for preparing a colored polylactic acid, comprising the steps of:
(a) synthesizing an aluminum catalyst and one or more ligands in a solvent to form an aluminum catalyst complex; and
(b) polymerizing polylactic acid by adding lactide monomers and a color determining selective initiator to the solvent and catalyst complex of step (a).

2. The method according to claim 1, wherein the solvent is an organic solvent.

3. The method according to claim 2, wherein the organic solvent is toluene, benzene, pentane, cyclopentane, hexane, cyclohexane, chloroform, diethyl ether or 1,4-dioxane.

4. The method according to claim 1, wherein the aluminum catalyst complex is prepared by mixing 1 equivalent of trimethylaluminum with 2 equivalents of C₅H₄N(CO)NHC₆H₃(NO₂)₂.

5. The method according to claim 1, wherein the color determining selective initiator comprises an alcohol functional group.

6. The method according to claim 5, wherein the selective initiator is HOCH₂(C₆H₄)N═N(C₆H₄)NH₂, 2-[N-ethyl-3-methyl-4-[(5-nitro-1,3-thiazol-2-yl)diazenyl]anilino]ethanol, 2-[4-(2-chloro-4-nitrophenyl)diazenyl-N-ethylanilino]ethanol, 1-pyrenebutanol or a mixture thereof.

7. The method according to claim 1, wherein the aluminum catalyst complex and the selective initiator are independently added in an amount of 0.5-0.7 part by weight based on 100 parts by weight of the lactide monomers.

8. The method according to claim 1, wherein the polylactic acid polymerization is performed at 160-250° C. for 0.5-3 hours.

9. A polylactic acid resin having a molecular weight of 50,000-200,000, which is prepared by the method according to claim 1.
